(19) United States
(12) Patent Application Publication
(10) Pub. No.: US 2002/0057337 A1
(43) Pub. Date: May 16, 2002

(54) Immersive time sequential imaging system

(76) Inventor: James J. Kumler, Jupiter, FL (US)

Correspondence Address: Dan Cleveland, Lathrop & Gage L.C., Suite 302, 4845 Pearl East Circle, Boulder, CO, 80301, US

(21) Appl. No.: 09/991,232

(22) Filed: Nov. 15, 2001

Related U.S. Application Data
(60) Provisional application No. 60/249,058, filed on Nov. 15, 2000.

(51) Int. Cl. H04N 13/02

(52) U.S. Cl. 348/47

(57) ABSTRACT

An immersive time sequential camera uses an array of back-to-back fisheye lenses to capture a 2π steradian field of view. A switch mechanism, such as a flip mirror or variable optical attenuator, permits capture of images comprising π steradians on adjacent frames or successive camera exposures.

### RELATED APPLICATIONS

This application claims benefit of priority to provisional application serial No. 60/249,058 filed Nov. 15, 2000, which is incorporated by reference to the same extent as though fully repeated herein.

### BACKGROUND OF THE INVENTION

1. Field of the Invention

The present invention pertains to the field of imaging cameras that capture images over unusually broad fields of view, such as fisheye lenses that capture images over approximately π steradians, and especially immersive photography devices that capture a 2π steradian scene.

2. Description of the Related Art

Photography, including digital and film photography, involves imaging a volumetric three dimensional space to a rectilinear planar or two dimensional space. Due to complexities in the optical pathway, the difficulty of this endeavor increases with the magnitude of the field of view, especially when the field of view exceeds approximately π steradians. A few attempts have been made to capture the entire 2π steradian scene that is visible from any particular vantage point, but these attempts require either multiple cameras or multiple exposures.

Prior systems for capturing broad fields of view over 2π steradians are either slow and cumbersome to operate or very expensive complex systems. For example, U.S. Pat. No. 5,023,725 to McCullen describes a dodecahedron for photography and projection of pentagonal images. A mask is used to filter out edge effects that arise at the lens junctions, and multiple recording devices are required to capture the entire field of view. For example, six pentagonal lenses may be deployed in a semi-dodecahedral to cover a hemispherical field of view. These six lenses require three image recording devices because a single recording device can only capture images from two of the pentagonal lenses at any one time. The requirement for multiple recording devices is redundant, expensive to manufacture, and adds to the overall system complexity.

Rotatable scanning systems are generally slow and have moving parts that are subject to breakage. For example, U.S. Pat. No. 5,659,804 to Keller describers a panoramic camera having a rotatable housing. The housing rotates around an axis of rotation that defines a viewpoint. Thus, the camera scans a 360° field of view over time. This type of system is poorly suited for making motion pictures, due to the time that is required for a complete revolution of the camera around the axis of rotation. Similarly, U.S. Pat. No. 5,086,311 to Naka et al. shows a panoramic camera having a mask that facilitates exposure of multiple images to different potions of a single frame, in order that panoramic images may be captured. U.S. Pat. No. 4,602,857 to Woltz et al. describes a motion picture camera that pivots on an axis of rotation.

U.S. Pat. No. 6,002,430 to McCall et al. describes a system that uses back to back fisheye lenses to capture a spherical field of view. Each lens provides an approximate 180° image to a corresponding camera, and the images from the respective cameras are processed to form a merged spherical image. This system is redundant and expensive because it requires the use of two full cameras.

U.S. Pat. No. 4,993,828 to Shaw et al. describes a dual aperture, dual film transport camera with two cameras positioned like Siamese twins for the purpose of recording separate images of the same scene. The images are separated by the ocular distance between an average person's right and left eyes. This technique entails narrow spatial separation of two fields for the purpose of stereoscopic imaging and projection.

There remains a need in the art to provide an immersive camera that functions simply without complex and cumbersome structure and which has an adequate motion response time for real time imaging over a broad field of view.

### SUMMARY

The present invention overcomes the problems that are discussed above and advances the art by providing an immersive time sequential imaging camera having a simplified structure that provides sufficient photographic response time for real time imaging uses.

According to the various embodiments and instrumentalities of the invention, the immersive imaging system comprises a camera, a first lens, a second lens, and an optical image processor, such as a switch, that is used to present the camera with alternative time sequenced images from the first lens and the second lens. Each lens has an individual field of view, for example, with deployment such that, in combination, the field of view from the respective lenses covers a broader field of view than is available from any one lens.

A camera interface connects an optical pathway from the lenses to the camera. The optical image processor, e.g., an electromechanical or electro-optical switch, is positioned in the optical pathway for relaying the individual fields of view to the camera interface at different times. The lenses may, for example, comprise a pair of back-to-back fisheye lenses, each having a hemispheric field of view, such as a field of view over about 185 degrees.

The camera may comprise a still camera or a motion picture camera. The camera may also be a film camera or a digital camera. A single camera may be connected to the cameral interface for capturing images comprising the individual fields of view allocated to the respective lenses. This instrumentality is accomplished, for example, through the use of an optical image processor comprising a switch that is configured to alternatively relay images from the respective lenses to the camera interface. This switch may be a time dependant switch that is constructed and arranged to alternatively relay the image from the optical image processor at intervals comprising, for example, the refresh rate for the digital camera, e.g., at intervals equal to or less than 0.5 seconds.

The switch comprising the optical image processor may be a spring loaded, two-sided mirror that is configured to alternatively relay images from the respective lenses to the camera interface. Alternatively, the switch may comprise an electro-optical liquid crystal, at least one variable retarder and analyzer, or a continuously variable linear polarizer.

Where the camera comprises a motion picture camera, the camera may be connected to the camera interface and timed in cooperation with the optical image processor for capturing the respective fields of view from the lenses, and alternatively as right and left hand images on adjacent frames. Alternatively, the images comprising a 2π steradian field of view may be captured on a single frame in like manner with the still camera. In the case of a motion picture camera, the switch may also be a rotating partial reflector disc synchronized to a frame rate of the motion picture camera.

The imaging system described above may be used according to a method of capturing optical images in a system having a first lens and a second lens in a selectively configurable optical pathway placing the first lens and the second lens in optical communication with a camera. The method comprises the steps of capturing an image from the first lens while the optical pathway is placed in a configuration that blocks transmissivity between the second lens and the camera while permitting transmissivity between the first lens and the camera; switching to reconfigure the optical pathway into a configuration that permits transmissivity between the second lens and the camera while blocking transmissivity between the first lens and the camera; and capturing an image from the second lens. The respective steps of capturing an image from the first lens and capturing an image from the second lens include respectively capturing the images on different frames, for example, onto successive film frames of a movie camera.

### BRIEF DESCRIPTION OF THE DRAWINGS

FIG. 1 depicts a first embodiment of the immersive imaging system in the form of a still camera;

FIG. 2 shows a flip mirror switch for use as the optical image processor;

FIG. 3 shows a variable retarder and analyzer for use as the optical image processor;

FIG. 4 depicts a first embodiment of the immersive imaging system in the form of a motion picture camera; and

FIG. 5 depicts a film having alternating right and left images captured thereon.

### DETAILED DESCRIPTION

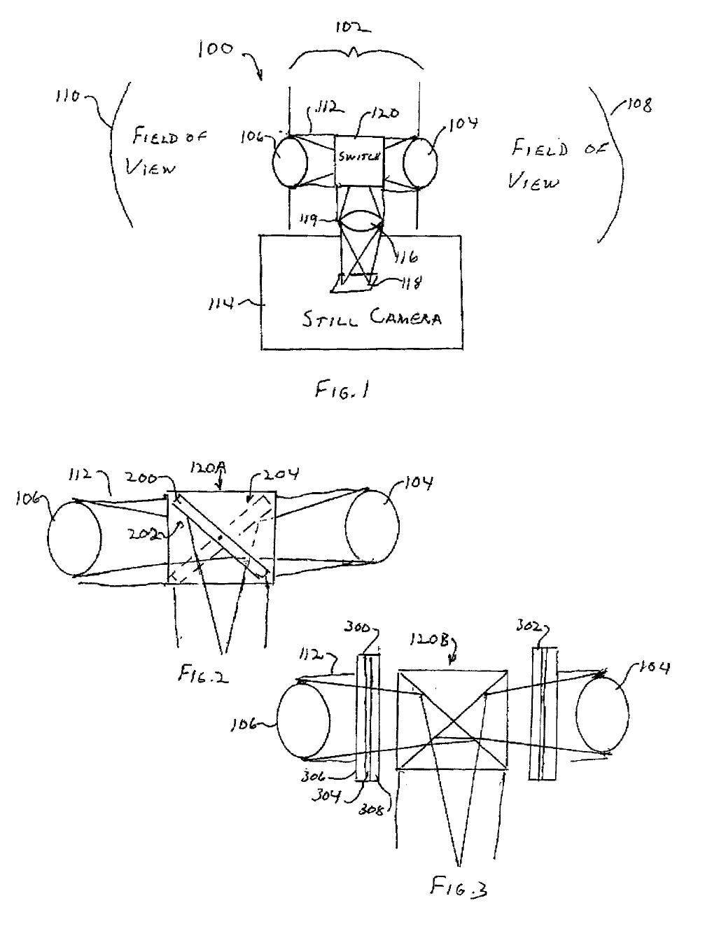

There will now be shown and described in FIG. 1, according to the various embodiments and instrumentalities of the immersive imaging camera, a still camera imager 100. A lens array 102 includes a first fisheye lens 104 and a second fisheye lens 106. Each of the fisheye lenses has a hemispherical field of view comprising about π steradians, which are respectively shown as a right hand field of view 108 and a left hand field of view 110. The fisheye lenses fields 104 and 106 are positioned back-to-back, such that fields of view 108 and 110, in combination, comprise a 2π steradian field of view. Those skilled in the art will appreciate that the fisheye lenses 104, 106, may be single lenses or multi-element lenses on respective branches of optical pathway 112. The fields of view 108 and 110 may overlap slightly, e.g., as 185° fields of view, to assure that the combined 2π steradian field of view field is obtained despite a slight physical separation of the fisheye lenses 104 and 106. An optical pathway 112 may include a tube or fiber optic cable to assist controlling the light. The optical pathway 112 places the fisheye lenses 104 and 106 in optical communication with a still camera 114, which may be a conventional digital camera or a film camera having a camera lens 116 and an film gate, such as a shutter mechanism 118. A camera interface 119 may be a rubber tube or a specialized lens assembly that physically and optically interconnects the optical pathway 112 with the still camera 114.

The optical pathway 112 contains an optical image processor, such as a switch mechanism 120. The switch mechanism is used to relay alternate images from the first fisheye lens 104 and the second fisheye lens 106 to the still camera 114. The manner of relaying images from the fisheye lenses 104 and 106 is such that at a first point in time the image from the first fisheye lens 104 is exposed to the still camera 114 for capture while switch 120 blocks the image from the second fisheye lens 106. Switch 120 then reconfigures the optical pathwayl 12 to block the image from the first fisheye lens 104 and permit passage of the image from the second fisheye lens 106. At a second point in time, the second image from the second fisheye lens 106 is exposed to still camera 114 for capture. Accordingly, the resultant image on a single frame of film or a single digital memory may occupy a 2π steradian field of view where approximately π steradians have been captured at different times. The captured image may, for example, comprise two circular fields on a single frame.

While the 2π steradian field of view may be captured on a single frame as a double exposure, it is more preferred in many instances to advance the frames between exposures for capturing alternate right and left hand images on adjacent frames. This second manner of capturing the images provides improved resolution for projection of the captured images. In this case, the 2π steradian captured image comprises two circular fields, i.e., right and left hand images, on adjacent frames.

The switching rate of switch 120 is preferably equal to or greater than the refresh rate of the still camera 114, when the still camera 114 is a digital camera. This refresh rate is typically about 0.5 seconds for digital cameras. Thus, according to the various embodiments and instrumentalities, the switching speed for digital cameras is limited by the camera refresh rate, and not by the switching speed.

FIG. 2 provides additional detail concerning the switch mechanism 120, which is shown as switch 120A, namely, a flip mirror embodiment that operates according to the above description of switch 120. As shown in FIG. 2, the switch mechanism 120A is an optomechanical spring-loaded flip mirror switch that includes an electronically actuated flip mirror 200. Mechanical switches including flip mirrors are well known in the art of optical switching. The flip mirror 200 may occupy a position 202, which blocks light from the first fisheye lens 104 and permits passage of light from the second fisheye lens 106. Electromechanical actuation of the flip mirror 200 to position 204 (shown in phantom in FIG. 2) permits passage of light from the first fisheye lens 104 and blocks passage of light from the second fisheye lens 106. Switch mechanism 120A contains all of the optomechanical switching circuitry that is required for operation of flip mirror switch 120A.

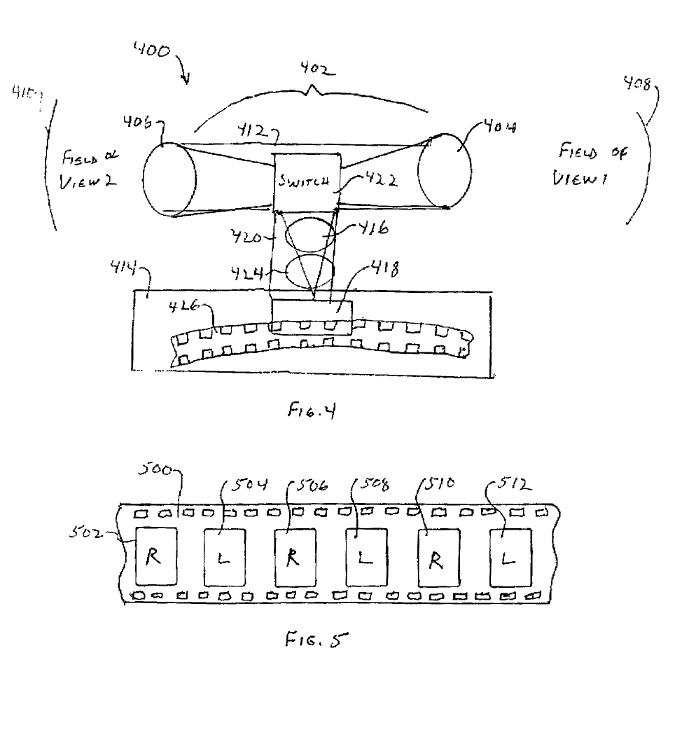

FIG. 3 provides additional detail concerning the switch mechanism 120, which is shown as switch 120B, namely, a variable retarder and analyzer that operates according to the above description of switch 120. Electro-optical switches have been described and used to switch between left eye view and right eye view of a scene for purposes of stereoscopic imaging and projection. U.S. Pat. No. 5,402,191 to Dean et al., which is hereby incorporated by reference to the same extent as though fully disclosed herein, describes switching apparatus and methodology that employ a variable retarder and analyzer for stereoscopic switching purposes. Switch 120B uses an identical pair of variable retarders and analyzers 300 and 302, each allocated to a corresponding fisheye lens 104 or 106. As in the case of variable retarded and analyzer 300, a thin polymer film 304 is sandwiched between a pair of opposed linear polarizers 306 and 308. The linear polarizers 306 and 308 are aligned with their preferential axes in orthogonal relationship to one another. Application of an electric field to the thin polymer layer 304 causes the resultant variable attenuator to switch from maximum transmittance to opaque in milliseconds. Contrast ratios of 1000:1 are possible. The thin polymer film 304 may be divided into a grid or other type of mask that can be used to selectively block transmittance of light on optical pathway 112, for example, where the fields of view from fisheye lenses 104 and 106 overlap. Switch 120B may contain all of the associated circuitry that is required to drive variable retarder and analyzer 120B. A conventional electronically configurable liquid crystal panel may be substituted for one or both of the variable analyzer and retarders 300, 302 that are shown in FIG. 3.

There will now be shown in FIG. 4 a second embodiment of the immersive imaging camera, which is a motion picture camera 400. A lens array 402 includes a first fisheye lens 404 and a second fisheye lens 406. Each of the fisheye lenses has a hemispherical field of view comprising about π steradians, which are respectively shown as a right hand field of view 408 and a left hand field of view 410. The fisheye lenses 404 and 406 are positioned back-to-back, such that fields of view 408 and 410, in combination, comprise a 2π steradian field of view. Alternatively, the fisheye lenses 404 and 406 may have different fields of view, such as a 30° field allocated to lens 404 and a 450 field allocated to lens 406. The fields of view 408 and 410 may overlap slightly, e.g., as 185° fields of view, to assure that the combined 2π steradian field of view field in maintained.

An optical pathway 412 places the fisheye lenses 404 and 406 in optical communication with a motion picture camera 414, which may be a conventional digital camera or a film camera having a camera lens 416 and a film gate 418. A camera interface 420 may be a rubber tube or a specialized lens assembly that connects the optical pathway 412 with the motion picture camera 414. Those skilled in the art should appreciate that optical pathway 412 may include additional lenses or fiber optics to relay respective images from the lenses 404, 406 to camera 414. For example, lens 416 may work in cooperation with the first lens 404 or the second lens 406, depending upon the configuration of switch 422. Similarly, either lens 404 or 406 may comprise a series of successive lenses (not shown) preceding switch 422. Additionally, lenses 404, 406 may image any field of view, such as 30° or 45°.

The optical pathway 412 contains an optical image processor, such as a switch 422. The switch 422 is used to relay alternate images from the first fisheye lens 404 and the second fisheye lens 406 to the motion picture camera 414. The manner of relaying images from the fisheye lenses 404 and 406 is such that at a first point in time the image from the first fisheye lens 404 is exposed to the motion picture camera 414 for capture while switch 422 blocks the image from the second fisheye lens 406. Switch 422 then reconfigures the optical pathway 412 to block the image from the first fisheye lens 404 and permit passage of the image from the second fisheye lens 406. At a second point in time, the second image from the second fisheye lens 406 is exposed to the motion picture camera 414 for capture. A rotating disc 424 having alternating mirror coated and transmissive segments spins at a constant velocity and is synchronized with the film rate of the film gate 418, as is the case in most conventional motion picture cameras.

The switch 422 may, for example, be identical to the switches 120A and 120B that are shown in FIGS. 2 and 3. Exposure is made on a single frame of film 426 (or the digital equivalent thereof) in like manner with the still camera 114 shown in FIG. 1.

In the motion picture camera 400, it is especially preferred to capture alternating images on different frames of film 500, as shown in FIG. 5. After exposure through switch mechanism 422, frames 502, 504, 506, 508, 510 and 512 contain alternating right and left hand images, i.e., photography proceeds more quickly on a real time image basis because no single frame is exposed to both right and left hand images. For example, switch 422 is actuated to expose frame 502 with a right hand image, film 500 is advanced while switch 422 is blocking the image from the first fisheye lens 404 and transmit light from the second fisheye lens 406, and frame 504 is then exposed to capture the left hand image from the second fisheye lens 406.

Playback or projection of the captured images may include replacing the still camera 114 or the motion picture camera 414 with a projector mechanism. The still camera images may be played back stereoscopically, while the motion picture images may also be projected using a switch mechanism 120 or 422 in a reverse optical pathway 412. In other words, the optical components of FIGS. 1-4 may be output backwards to project images to viewers.

The invention in its broader aspects is not limited to the specific details, representative devices and methods, and illustrative examples shown and described. Accordingly, departures may be made from such details without departing from the spirit or scope of the general inventive concept as defined by the appended claims and their equivalents.

We claim:

1. An immersive imaging system, comprising:
a first lens having a first field of view;
a second lens having a second field of view; and
an optical image processor for relaying the first and second fields of view in alternating time sequence to a camera interface.

2. The system as set forth in claim 1, the first and second lenses cooperating with the image processor to image a combined field of view at the camera interface, the combined field of view being larger than either of the first or second fields of view.

3. The system as set forth in claim 2, the combined field of view covering at least about 2π steradians.

4. The system as set forth in claim 1, the first lens comprising a first plurality of lens elements.

5. The system as set forth in claim 4, the second lens comprising a second plurality of lens elements.

6. The system as set forth in claim 5, the first plurality of lens elements and the second plurality of lens elements sharing at least one lens element in common.

7. The system as set forth in claim 1, further comprising one of a digital focal plane and optical film to record one or both of the first and second fields of view through the camera interface.

8. The system as set forth in claim 7, further comprising a digital camera with the digital focal plane.

9. The system as set forth in claim 8, the digital camera coupling with the camera interface to cooperatively record images of the first and second fields of view.

10. The system as set forth in claim 7, further comprising a photographic camera with the optical film.

11. The system as set forth in claim 10, the photographic camera coupling with the interface to cooperatively record images of the first and second fields of view.

12. The system as set forth in claim 1, wherein one or both of the first and second lenses comprises a fisheye lens each having a substantially hemispheric field of view.

13. The system as set forth in claim 12, wherein the hemispheric field of view comprises about 185 degrees.

14. The system as set forth in claim 1, the optical image processor comprising a switch configured to alternatively relay the first and second fields of view to the interface.

15. The system as set forth in claim 14, wherein the switch comprises a time dependant switch constructed and arranged to alternatively relay the first and second fields of view at intervals of at least about a refresh rate for a digital camera.

16. The system as set forth in claim 1, the optical image processor comprising a switch configured to alternatively relay images from the first and second lenses to the camera interface at intervals equal to or less than 0.5 seconds.

17. The system as set forth in claim 1, the optical image processor comprising a switch having a two-sided mirror configured to alternatively relay images from respective first and second lenses to the camera interface.

18. The system as set forth in claim 17, the mirror being spring-loaded.

19. The system as set forth in claim 1, the optical image processor having a switch response time not greater than 0.5 seconds.

20. The system as set forth in claim 1, the optical image processor comprising a switch having an electro-optical liquid crystal.

21. The system as set forth in claim 1, wherein the optical image processor comprises a switch having at least one variable retarder.

22. The system as set forth in claim 20, wherein the optical image processor comprises a switch having at least one analyzer.

23. The system as set forth in claim 1, wherein the optical image processor comprises a switch having a continuously variable linear polarizer.

24. The system as set forth in claim 1, wherein the camera comprises a still camera connected to the camera interface and cooperating with the optical image processor for capturing the respective fields of view from the lenses as a combined still image encompassing a combined field of view covering 2π steradians.

25. The system as set forth in claim 1, further comprising a motion picture camera connected to the camera interface and timed in cooperation with the optical image processor for capturing the respective fields of view from the lenses alternatively as alternative images on adjacent frames.

26. The system as set forth in claim 1, further comprising a motion picture camera connected to the camera interface and timed in cooperation with the optical image processor for capturing the respective fields of view from the lenses as a combined image encompassing the combined field of view covering 2π steradians on single frames.

27. The system as set forth in claim 26, further comprising a motion picture camera connected to the camera interface, the first and second lenses comprising a pair of fisheye lenses each having a hemispheric field of view.

28. The system as set forth in claim 27, wherein the hemispheric fields of view comprise about 185 degrees.

29. The system as set forth in claim 26, wherein the optical image processor comprises a switch configured to alternatively relay images from the respective lenses of the lens array to the camera interface.

30. The system as set forth in claim 26, wherein the optical image processor comprises a switch having a spring loaded two-sided mirror configured to alternatively relay images from the respective lenses of the lens array to the camera interface.

31. The system as set forth in claim 26, wherein the optical image processor comprises a switch having an electro-optical liquid crystal.

32. The system as set forth in claim 26, wherein the optical image processor comprises a switch having at least one variable retarder and analyzer.

33. The system as set forth in claim 26, wherein the optical image processor comprises a switch having a continuously variable linear polarizer.

34. The system as set forth in claim 26, wherein the optical image processor comprises a rotating partial reflector disc synchronized to a frame rate of the motion picture camera.

35. In an imaging device having a first lens and a second lens, the improvement comprising:
a camera for use in recording images from the first lens and the second lens; and
an optical switching mechanism for use in providing the camera with time-sequenced alternating images from the first lens and the second lens.

36. A method of capturing optical images in a system having a first lens and a second lens in a selectively configurable optical pathway placing the first lens and the second lens in optical communication with a camera, the method comprising the steps of:
capturing an image from the first lens while the optical pathway is placed in a configuration that blocks transmissivity between the second lens and the camera while permitting transmissivity between the first lens and the camera;
switching to reconfigure the optical pathway into a configuration that permits transmissivity between the second lens and the camera while blocking transmissivity between the first lens and the camera; and
capturing an image from the second lens.

37. The method according to claim 36, wherein the respective steps of capturing an image form the first lens and capturing an image from the second lens include respectively capturing the images on different frames.
